(19) United States
(12) Patent Application Publication
(10) Pub. No.: US 2020/0281162 A1
(43) Pub. Date: Sep. 10, 2020

(54) ELECTROMAGNETIC FREQUENCY REMEDIATION FOR CANINES

(71) Applicant: EMF FRIENDLY, INC., Laguna Niguel, CA (US)

(72) Inventors: John A. Robbins, Costa Mesa, CA (US); Todd Evan Fligner, Laguna Niguel, CA (US)

(21) Appl. No.: 16/812,180

(22) Filed: Mar. 6, 2020

Related U.S. Application Data
(60) Provisional application No. 62/919,260, filed on Mar. 6, 2019.

(51) Int. Cl. A01K 27/00

(52) U.S. Cl. CPC A01K 27/009; A01K 27/001

(57) ABSTRACT

The present invention is directed to the prevention of EMF wave damage to the cells of living creatures. The invention features a collar that may comprise a base strip comprising a webbing material and having two ends with a fastener disposed on each end. The fasteners may comprise Velcro, buckles, or any other medium that allows for the attachment of surfaces. The collar may further comprise a container holding a remediation material that converts chaotic EMF waves into non-damaging waves. The container may be disposed on a surface of the collar and covered by a label. The fasteners may connect in a way such that the base strip is formed into a non-twisting loop with the container and label disposed on an outward-facing surface of the loop.

### CROSS-REFERENCES TO RELATED APPLICATIONS

This application is a non-provisional and claims benefit of U.S. Provisional Application No. 62/919,260 filed Mar. 6, 2019, the specification of which is incorporated herein in their entirety by reference.

### FIELD OF THE INVENTION

The present invention is directed to electromagnetic frequency waves and the prevention of cell damage as a result of said waves.

### BACKGROUND OF THE INVENTION

Electromagnetic frequency (EMF) is used in many products in many fields, such as communications, military weapons, and many commercial products. It is increasing in proliferation throughout the world and being promoted due to its ability to be used in Wi-Fi, Smart meters, cell phones, etc. The technology is expanding and promoted with broad usage because of its ability to penetrate concrete structures and other structures that are not able to allow other forms of energy to do so.

Consequently, much of the world is being blanketed by this energy. The primary focus of concern for the use of microwaves by governments throughout the world is on the heat it generates when it comes to safety for humans and animals. This is not the worst aspect of the technology when used as communications devices, but more investigation needs to be focused on this area of the technology.

There are, however, over 10,000 studies from scientists around the world showing many dangers that are being ignored by those promoting the technology. Electromagnetic frequency waves have been shown to have adverse effects on the cells of humans and animals. Animals have no say in where they are located, housed, and placed by humans and wild animals are being affected in a negative way in regard to their health as many studies are now being produced. The hierarchy of damage begins with the most vulnerable, the fetus in the wombs of pregnant animals and humans.

Studies are beginning to show how this damage is caused. Cancer is on the increase and EMF has been identified as a major factor and cause. Many other diseases and conditions can be traced back to this microwave technology.

Research has shown that the cells of animals, when placed in an EMF environment, open up their voltage gate calcium channels to allow calcium to flood the cell causing DNA damage, and inhibit the ability of the cell to process nitric oxide, a vital source of energy production for the cells.

The EMF causes red blood cells to coagulate and bunch together, making it impossible for oxygen to flow to areas that are fed by capillaries only. The diameter of a capillary is about 6.2 to 8.2 microns, and the diameter of red blood cells carrying the oxygen to tissues is approximately 7 microns, making only one red blood cell at a time able to move easily through the capillaries. When a blockage occurs, growth and repair of tissues becomes greatly inhibited. Capillaries have only one layer of endothelium, unlike arteries that have three layers with one being a muscle layer that communicates with the brain. This lack of communication means the brain has no idea if the blood flow diminishes in capillaries.

Capillaries make up about 75% of the blood vessels in the body. There are many areas in the body only fed by capillaries. These areas are called watershed areas, such as valves in the heart and areas in the brain like the respiratory area. Many disease conditions and syndromes can be caused by the lack of oxygen being delivered to these watershed areas.

Proposed solutions have been to eliminate the EMF in the environment surrounding humans and animals, but when doing so, it reduces and even eliminates the ability to utilize the devices. Reflecting and absorbing the waves have also dominated the solutions, again eliminating or reducing the usefulness of the technologies, so the popularity of this type of remediation has not been very successful.

Because the desire to continue microwave technology is so strong, the ideal remediation is to correct the damaging waves before they can affect animals and humans so the use of devices may be allowed while reducing or eliminating the damage. Prior systems have attempted to use a combination of earth-based materials to remediate EMF damage by harmonizing the subatomic particles affected by EMF, but have found little success as prior applications disrupt the harmonizing effects of the remediation material.

### BRIEF SUMMARY OF THE INVENTION

It is an objective of the present invention to provide devices for dogs that allow for the prevention of cell damage as a result of EMF waves, as specified in the independent claims. Embodiments of the invention are given in the dependent claims. Embodiments of the present invention can be freely combined with each other if they are not mutually exclusive.

The present invention features a collar capable of converting chaotic EMF waves into non-damaging waves to allow for improved physical well-being of a creature wearing said collar. The collar may comprise a base strip with a first end and a second end, a first fastener disposed on the first end, and a second fastener disposed on the second end.

The base strip may comprise a webbing material. The fasteners may comprise a hook and loop, buckles, or any other medium that allows surfaces to connect. The collar may further comprise a container holding a remediation material that is capable of converting chaotic EMF waves into non-damaging waves. The container may be attached to a surface of the base strip and a label may be disposed over the container to protect it from external harm. The first fastener may be capable of connecting to the second fastener, thus forming the base strip into a non-twisting loop with the container and label disposed on an outward-facing surface of the loop. The collar may further comprise a leash ring.

One of the unique and inventive technical features of the present invention is the position of the remediation material in a bag disposed on a position of the collar close to the wearer. Without wishing to limit the invention to any theory or mechanism, it is believed that the technical feature of the present invention advantageously provides for efficient prevention of EMF wave damage to the cells of the wearer in a manner that does not obstruct the material's harmonizing capabilities. None of the presently known prior references or work has the unique inventive technical feature of the present invention. Furthermore, this feature is counterintuitive. The reason that it is counterintuitive is because prior systems teach the placement of remediation material within a wearable device. Thus, the prior art teaches away from the present invention. Surprisingly, the placement of remediation material in a bag disposed on a position of the collar close to the wearer was found to effectively prevent the adverse effects of EMF waves.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a schematic of an embodiment of the present invention.

FIG. 2A shows an embodiment of a dog collar of the present invention.

FIG. 2B shows a diagram of the embodiment of the dog collar of FIG. 1A.

FIG. 3 shows a diagram of an embodiment of a dog collar of the present invention with buckles used as the fastening mechanism.

FIG. 4 shows a flow chart of a method of preventing adverse effects of EMF waves.

### DETAILED DESCRIPTION OF THE INVENTION

Following is a list of elements corresponding to a particular element referred to herein:
1 collar
10 container
20 base strip
32 first fastener
34 second fastener
40 label
100 hook and loop collar
110 container of hook and loop collar
120 base strip of hook and loop collar
132 first fastener of hook and loop collar
134 second fastener of hook and loop collar
140 label of hook and loop collar
200 buckle collar
210 container of buckle collar
220 base strip of buckle collar
232 first fastener of buckle collar
234 second fastener of buckle collar
240 label of buckle collar
250 leash ring

One product of the present invention is a collar. By using a plastic bag containing elements that change the EMF chaotic field into smooth non-damaging waves, the result is a great health benefit. The microwaves being emitted by devices are chaotic in form and it is this chaos that causes damage to cells. By “smoothing out” the chaos, the damaging waves are remediated. One such example of this method was done by taking a first live blood analysis on a dog to act as a baseline, placing a plastic bag containing ¾ of a teaspoon of material provided by a company called EMF Solutions, Inc. on a collar made of nylon webbing material, taking a second live blood analysis on the same dog now wearing the collar, and comparing the second live blood analysis to the first live blood analysis. The results showed healthier and more separated red blood cells in the second live blood analysis, demonstrating the effectiveness of the experiment.

The collar is designed to reduce the chaos of the waves, thereby remediating the DNA damage. Blood samples taken from a dog before, during, and after exposure to strong EMF devices, like Wi-Fi, with and without the remediation collar demonstrate the effectiveness of the invention. Incorporating the remediation elements on the collar allows for maximizing the effect on the animal. By putting the material under the label, the material is protected from damage and becomes closer to the animal than a pendant or other form of attachment would offer.

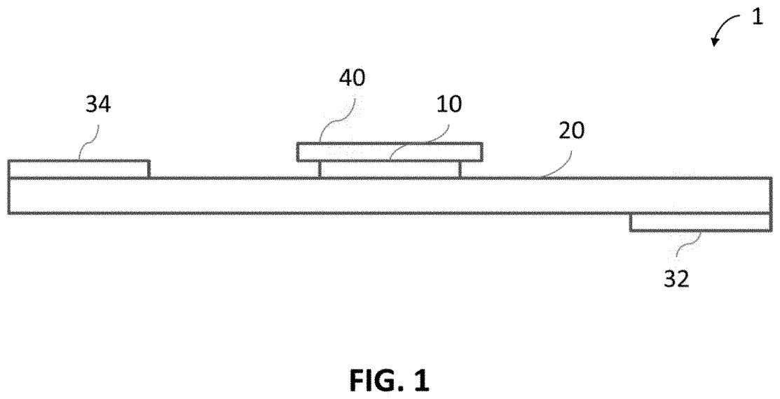

Referring to FIG. 1, the present invention features an electromagnetic frequency (EMF) remediation collar (1) for converting chaotic EMF waves into non-damaging waves. In some embodiments, the collar (1) may comprise a base strip (20) having a first end and a second end. The base strip may comprise a nylon webbing material. The collar (1) may further comprise a first fastener (32) disposed on the first end of the base strip and a second fastener (34) disposed on the second end of the base strip. The first fastener (32) and the second fastener (34) may comprise a hook and loop fastener, a buckle, or any medium that allowed surface to attach to each other. The collar (1) may further comprise a covered container (10) attached to the base strip with a remediation material disposed within the container. The covered container (10) may comprise a plastic bag and may have a cover (40) disposed on top of it. The covered container (10) may have 0.5-0.75 teaspoons of remediation material disposed within it. The remediation material may comprise a plurality of earth-based elements. The first fastener (32) may be attachable to the second fastener (34), such that the base strip (20) forms a loop when both fasteners are connected. In some embodiments, the first fastener (32) and the second fastener (34) are connected such that the loop created by the base strip (20) when the first fastener (32) is connected to the second fastener (34) is non-twisted and the covered container (10) is disposed on an outward-facing surface of the loop. The remediation material may be capable of passively converting chaotic EMF waves into non-damaging waves. The collar (1) may be intended for use by dogs. The collar (1) may further comprise a leash ring (250).

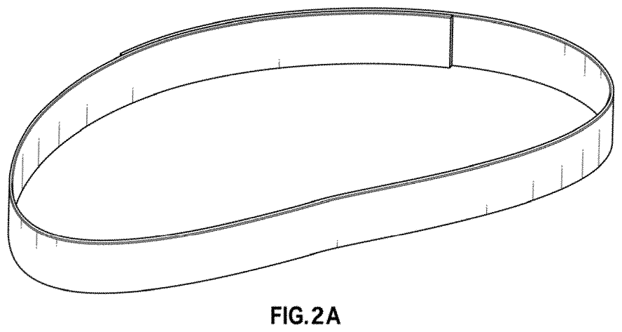

Referring now to FIG. 2A-B, the present invention features an EMF remediation animal collar (100) for converting chaotic EMF waves into non-damaging waves. In some embodiments, the collar (100) may comprise a base strip (120) comprising a webbing material and having a first and second end. The collar (100) may further comprise a first fastener (132) comprising a hooked fastener disposed on the first end of the base strip, and a second fastener (134) comprising a looped fastener disposed on the second end of the base strip. The collar (100) may further comprise a bag (110) attached to the base strip (120) and a remediation material disposed within the bag (110). The bag (110) may have a cover (140) disposed over it. The bag may have 0.5-0.75 teaspoons of remediation material disposed within it. The remediation material may comprise a plurality of earth-based elements. In some embodiments, the first fastener (132) may be attachable to the second fastener (134), such that the base strip (120) forms a loop when both fasteners are connected. The first fastener (132) and the second fastener (134) may connect such that the loop is non-twisted and the bag (110) and cover (140) are disposed on an outward-facing surface of the loop. The remediation material may be capable of passively converting chaotic EMF waves into non-damaging waves. The collar (100) may be intended for use by dogs. The collar (100) may further comprise a leash ring (250).

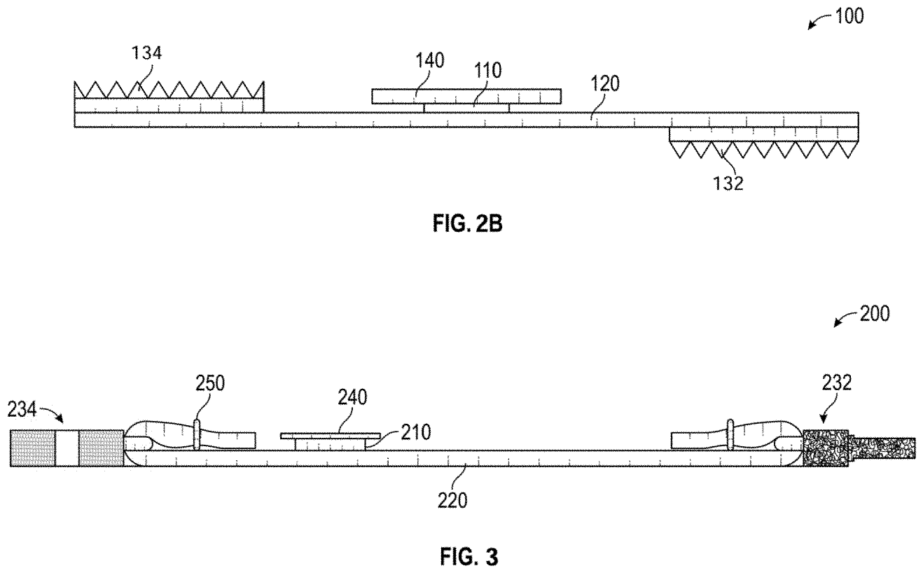

Referring now to FIG. 3, the present invention features an EMF remediation animal collar (200) for the conversion of chaotic EMF waves into non-damaging waves. In some embodiments, the collar (200) may comprise a base strip (220) comprising a webbing material and having a first and second end. The base strip (220) may comprise a nylon webbing material. The collar (200) may further comprise a first fastener (232) comprising a male buckle member disposed on the first end of the base strip (220), and a second fastener (234) comprising a female buckle member disposed on the second end of the base strip (220). The collar (200) may further comprise a bag (210) attached to the base strip (220) with a remediation material disposed within the bag (210). The bag (210) may have a cover (240) disposed on top of it. The bag (210) may have 0.5-0.75 teaspoons of remediation material disposed within it. The remediation material may comprise a plurality of earth-based elements. The first fastener (232) may be attachable to the second fastener (234), such that the base strip (220) forms a loop when both fasteners are connected. The first fastener (232) and the second fastener (234) may be positioned such that the loop is non-twisted and the bag (210) and cover (240) may be disposed on an outward-facing surface of the loop. The remediation material may be capable of passively converting chaotic EMF waves into non-damaging waves. The collar (200) may be intended for use by dogs. The collar (200) may further comprise a leash ring (250).

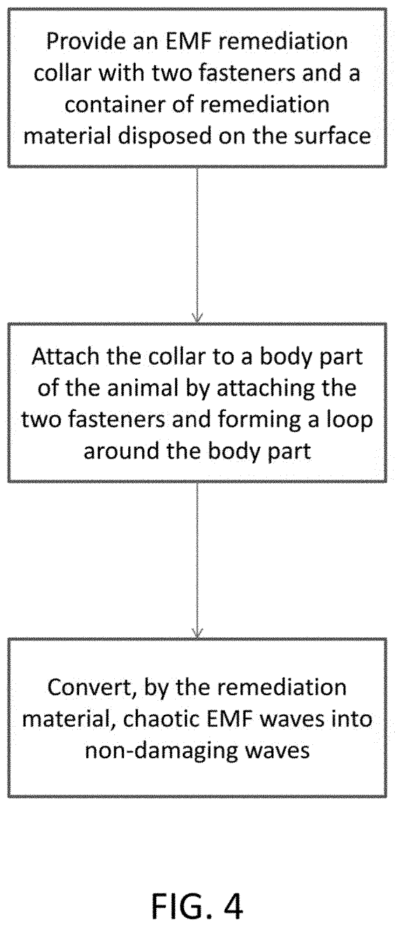

Referring to FIG. 4, the present invention features a method for preventing adverse effects of EMF waves in an animal. In some embodiments, the method may comprise providing an EMF remediation collar (1) comprising a base strip (20) having a first end and a second end, a first fastener (32) disposed on a first end of the base strip, a second fastener (34) disposed on a second end of the base strip, a covered container (10) disposed on the base strip, and a remediation material disposed within the covered container (10). The covered container (10) may have 0.5-0.75 teaspoons of remediation material disposed within it. The remediation material may comprise a plurality of earth-based elements. The first fastener (32) may be attachable to the second fastener (34).

The method may further comprise attaching the collar (1) to a body part of the animal by attaching the first fastener (32) to the second fastener (34), such that the base strip (20) forms a loop around the body part of the animal. Finally, the method may comprise passively converting, by the remediation material, chaotic EMF waves into non-damaging waves. In some embodiments, the animal is a dog.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. An electromagnetic frequency (EMF) remediation collar (1) for converting chaotic EMF waves into non-damaging waves, the collar (1) comprising:
a. a base strip (20) having a first end and a second end;
b. a first fastener (32) disposed on the first end of the base strip;
c. a second fastener (34) disposed on the second end of the base strip;
d. a covered container (10) attached to the base strip; and
e. a remediation material disposed within the container;
wherein the first fastener (32) is attachable to the second fastener (34), such that the base strip (20) forms a loop when both fasteners are connected; and
wherein the covered container (10) is disposed on an outward-facing surface of the loop.

2. The collar (1) of claim 1, wherein the base strip (20) comprises a webbing material.

3. The collar (1) of claim 2, wherein the webbing material comprises nylon.

4. The collar (1) of claim 1, wherein the first fastener (32) and the second fastener (34) comprise a hook and loop fastener.

5. The collar (1) of claim 1, wherein the first fastener (32) comprises a male buckle member and the second fastener (34) comprises a female buckle member.

6. The collar (1) of claim 1, wherein the covered container (10) is a plastic bag.

7. The collar (1) of claim 1, wherein the covered container (10) comprises a container covered by a label (40).

8. The collar (1) of claim 1, wherein the remediation material comprises a plurality of earth-based elements.

9. The collar (1) of claim 1, wherein 0.5-0.75 teaspoons of remediation material are disposed within the bag (10).

10. The collar (1) of claim 1, wherein the first fastener (32) and the second fastener (34) are connected such that the loop created by the base strip (20) when the first fastener (32) is connected to the second fastener (34) is non-twisted.

11. The collar (1) of claim 1, wherein the remediation material is capable of passively converting chaotic EMF waves into non-damaging waves.

12. The collar (1) of claim 1, wherein the collar (1) is a dog collar.

13. The collar (1) of claim 1 further comprising a leash ring (250).

14. An EMF remediation animal collar (100) for converting chaotic EMF waves into non-damaging waves, the collar (100) comprising:
a. a base strip (120) comprising a webbing material and having a first and second end;
b. a first fastener (132) comprising a hooked fastener and disposed on the first end of the base strip;
c. a second fastener (134) comprising a looped fastener and disposed on the second end of the base strip;
d. a bag (110) attached to the base strip (120);
e. a remediation material disposed within the bag (110); and
f. a cover (140) disposed over the bag (110);
wherein the first fastener (132) is attachable to the second fastener (134), such that the base strip (120) forms a loop when both fasteners are connected;
wherein the first fastener (132) and the second fastener (134) connect such that the loop is non-twisted; and
wherein the bag (110) and cover (140) are disposed on an outward-facing surface of the loop.

15. The collar (100) of claim 14, wherein the remediation material comprises a plurality of earth-based elements.

16. The collar (100) of claim 14, wherein 0.5-0.75 teaspoons of remediation material are disposed within the bag (110).

17. The collar (100) of claim 14, wherein the remediation material is capable of converting chaotic EMF waves into non-damaging waves.

18. The collar (100) of claim 14 further comprising a leash ring (250).

19. A method for preventing adverse effects of EMF waves in an animal, the method comprising:
a. providing an EMF remediation collar (1), the collar comprising:
i. a base strip (20) having a first end and a second end,
ii. a first fastener (32) disposed on a first end of the base strip,
iii. a second fastener (34) disposed on a second end of the base strip,
iv. a covered container (10) disposed on the base strip, and
v. a remediation material disposed within the covered container,
wherein the first fastener (32) is attachable to the second fastener (34);
b. attaching the collar (1) to a body part of the animal by attaching the first fastener (32) to the second fastener (34), such that the base strip (20) forms a loop around the body part of the animal and the covered container (10) is disposed on an outward-facing surface of the loop;
c. converting passively, by the remediation material, chaotic EMF waves into non-damaging waves.

20. The method of claim 19, wherein the remediation material comprises a plurality of earth-based elements.
